(19) United States
(12) Patent Application Publication
(10) Pub. No.: US 2025/0071666 A1
(43) Pub. Date: Feb. 27, 2025

(54) METHODS, APPARATUS AND SYSTEMS FOR PERSONAL INTERNET OF THINGS NETWORK GATEWAY SELECTION

(71) Applicant: InterDigital Patent Holdings, Inc., Wilmington, DE (US)

(72) Inventors: Anuj Sethi, Ottawa (CA); Xiaoyan Shi, Lake Oswego, OR (US); Taimoor Abbas, Sainte-Julie (CA); Michael Starsinic, Newtown, PA (US); Tezcan Cogalan, London (GB); Saad Ahmad, Montreal (CA)

(73) Assignee: InterDigital Patent Holdings, Inc., Wilmington, DE (US)

(21) Appl. No.: 18/726,229

(22) PCT Filed: Jan. 27, 2023
(86) PCT No.: PCT/US23/11697

§ 371 Date: Jul. 2, 2024

Related U.S. Application Data
(60) Provisional application No. 63/303,827, filed on Jan. 27, 2022.
(60) Provisional application No. 63/357,293, filed on Jun. 30, 2022.

(51) Int. Cl. H04W 48/16; H04W 84/18

(52) U.S. Cl. CPC H04W 48/16; H04W 84/18

(57) ABSTRACT

A wireless transmit/receive unit (WTRU) may receive parameters associated with a plurality of personal Internet of Things (IoT) network (PIN) gateways (GWs) connected to a PIN. The received parameters may comprise a PIN element type and one or more PIN policy parameters for each of the plurality of PIN GWs. The WTRU may determine a priority for each of the plurality of PIN GWs using the PIN element types and the one or more PIN policy parameters. The WTRU may generate, using the determined priorities, a prioritized list of PIN GWs available on the PIN. The WTRU may receive a connection request from a PIN element connected to the PIN. The WTRU may select one of the plurality of PIN GWs for the PIN element to use to establish connection to the core network.

### CROSS-REFERENCE TO RELATED APPLICATIONS

This application claims the benefit of U.S. Provisional Patent Application No. 63/303,827, filed on Jan. 27, 2022, and to U.S. Provisional Patent Application No. 63/357,293, filed on Jun. 30, 2022, the entire contents of which are incorporated herein by reference.

### BACKGROUND

The Internet of Things (IoT) is designed for devices that communicate using the cellular network. Devices with IoT capabilities require increased power consuming performance and increased network efficiency for bulk operations.

When multiple IoT devices are deployed in a private environment, the WTRUs with IoT capabilities can be organized in a personal IoT network (PIN). The PIN includes one or more PIN Elements, one or more PIN Management (Mgmt) devices, and one or more PIN gateways (GWs). A PIN element is a wireless transmit/receive unit (WTRU) or non-3GPP device that can communicate within a PIN. A PIN Mgmt device is a PIN element with capability to manage the PIN. A PIN GW is a PIN element that has the ability to provide connectivity to and from the core network for other PIN elements.

PIN elements may communicate with each other via the PIN GW and/or directly. PIN elements may communicate with the core network system to obtain core network services or communicate with a data network via the core network.

### SUMMARY

Methods and apparatuses are provided for personal Internet of Things (IoT) network (PIN) policy configuration and gateway (GW) selection. Methods and apparatuses are provided for PIN GW discovery and availability. Methods and apparatuses are provided for PIN GW prioritization, selection, and PIN creation.

A wireless transmit/receive unit (WTRU) may receive parameters associated with a plurality of PIN GWs connected to a PIN. The received parameters may comprise a PIN element type and one or more PIN policy parameters for each of the plurality of PIN GWs. The WTRU may determine a priority for each of the plurality of PIN GWs using the PIN element types and the one or more PIN policy parameters. The WTRU may generate, using the determined priorities, a prioritized list of PIN GWs available on the PIN. The WTRU may receive a connection request from a PIN element connected to the PIN. The WTRU may select one of the plurality of PIN GWs for the PIN element to use to establish connection to the core network. The connection request may indicate one or more requirements associated with the PIN element. The one of the plurality of PIN GWs may be selected based on the one or more requirements. The one of the plurality of PIN GWs may be selected based on one or more capabilities of the one of the plurality of PIN GWs. The PIN element type may comprise one or more of a sensor type, an augmented reality device, a virtual reality device, a smart light, a smart plug, and/or a WTRU. The PIN policy parameters may comprise one or more of PIN element types supported, data rates, core network connectivity, power source, quality of service supported, and/or network slice.

The WTRU may send a request to the core network for a PIN management policy. The parameters may be received in response to the request. The WTRU may receive a broadcast message from each of the plurality of PIN GWs. The broadcast message may comprise the received parameters. The WTRU may broadcast a PIN GW solicitation request. The PIN GW solicitation request may comprise an indication of desired PIN GW capabilities. The WTRU may receive a PIN GW solicitation response from each PIN GW connected to the PIN. Each of the PIN GW solicitation responses may comprise the desired PIN GW capabilities for a respective PIN GW. The WTRU may match PIN elements connected to the PIN with the plurality of PIN GWs based on requirements associated with the PIN elements and capabilities associated with the plurality of PIN GWs.

PEGC unavailability/non-suitability detection may be provided. Detection of PEGC unavailability may trigger PEGC selection and/or authorization. Detection of PEGC unavailability may trigger reconfiguration of the PIN.

A PIN may include a secondary PEMC, for example, for redundancy support. If the primary PEMC becomes unavailable, the secondary PEMC may service the PIN. Unavailability of the primary PEMC may trigger authorization of another PEMC (e.g., a secondary PEMC) to take over the PIN, for example, if the PIN has one (e.g., only one) PEMC.

A WRTU may include a one or more processor and/or memory. The WTRU may be configured to receive one or more reports. The one or more reports may be received from one or more other WTRUs. In some embodiments, each of the one or more reports may indicate one or more of personal Internet of Things network (PIN) gateways. The one or more PIN gateways may be discovered by the respective WTRU. In some embodiments, one or more of the PIN gateways may be associated with a respective PIN gateway ID.

The WRTU may be configured to receive PIN gateway selection policy information. The PIN gateway selection policy information may be received from network node. The network node may be a core network node. In some embodiments, the WTRU may be configured to select a PIN gateway from the one or more PIN gateways. The one or more PIN gateways may be selected for the one or more other WTRUs. The selection may be based on the PIN gateway selection policy information received. The selection policy information may be received from the core network node. The processor and/or memory may be configured to request a policy parameter. The policy parameter may be based on a type of PIN supported. In some embodiments, the processor and/or memory may be configured to send a solicitation request message. The solicitation request message may comprise relative data rates.

In some embodiments, the PIN gateway selection policy information may indicate one or more of a preferred PIN gateway, a type of PIN supported, a quality of service (QOS) supported, and an associated 5G core network identifier. The PIN gateway selection policy information may include a prioritized PIN gateway list received from the core network node. The prioritized PIN gateway list may be received from the core network node. Receipt may be based on a request sent from the WTRU to the core network node. In some embodiments the request may include location information.

In some embodiments, the processor and/or memory may be configured to transmit a gateway configuration to the one or more other WTRUs. The gateway configuration may include an indication that the one or more other WTRUs is selected as the PIN gateway. In some embodiments, the PIN gateway selection policy information may indicate a QoS. The QoS may be transmitted, for example, over non-access stratum (NAS).

In some embodiments, one or more policy parameters may be preconfigured. The preconfiguration may be at an application layer of the WTRU and/or may be received during an initial registration. The initial registration may be, for example, from the core network. In some embodiments, the initial registration may be at an application layer of the WTRU.

In some embodiments, the processor and/or memory may be configured to determine a priority for each of one or more of PIN gateways. The priority determination may be made based on PIN gateway selection policy information. The processor and/or memory may be configured to generate a prioritized list of PIN gateways available using the determined priorities, for example. In some embodiments a trigger message may be transmitted to the one or more other WTRUs. The processor and/or memory may be configured to send a trigger message to a second WRTU, for example, on a condition that the WTRU is unavailable. In some embodiments, the processor and/or memory may be configured to send an indication indicating the selected PIN gateway, for example, to another PIN element.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example home automation personal internet of things (IoT) network (PIN).

FIG. 3 depicts example wearable PINs.

FIG. 4 depicts an example PIN architecture.

FIG. 5 depicts an example process for proximity services (ProSe) direct discovery.

FIG. 6 depicts another example process for ProSe direct discovery.

FIG. 7 depicts an example process for PIN policy configuration.

FIG. 8 depicts another example process for PIN GW discovery.

FIG. 9 depicts another example process for PIN GW discovery.

FIG. 10 depicts an example process for requesting a list of PIN GWs from the core network.

FIG. 11 depicts an example process for PIN GW selection based on available PIN GW for each PIN element.

FIG. 12 depicts an example process for PIN GW selection and PIN creation.

FIG. 13 depicts an example process for PIN GW prioritization.

FIG. 14 depicts an example change in association between a PIN element (PINE) and a PIN element with gateway capabilities (PEGC).

FIG. 15 depicts an example change in PIN element with management capabilities (PEMC) from a primary PEMC (P) to a secondary PEMC(S).

### DETAILED DESCRIPTION

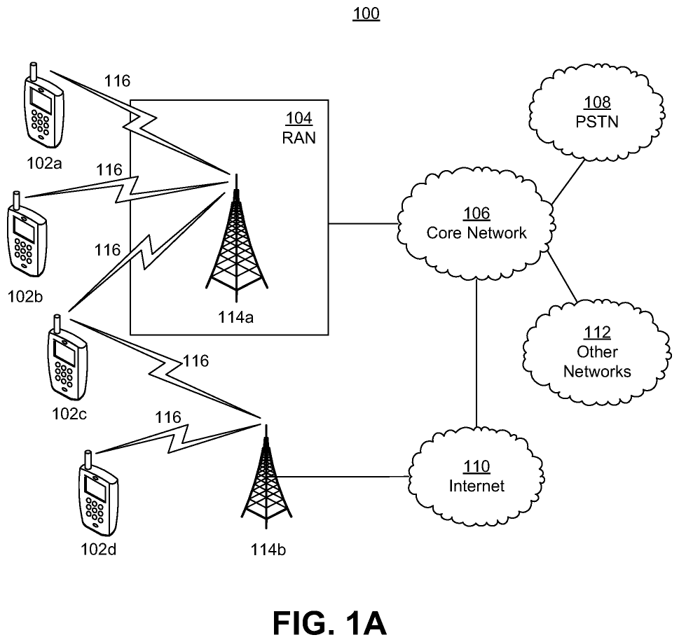

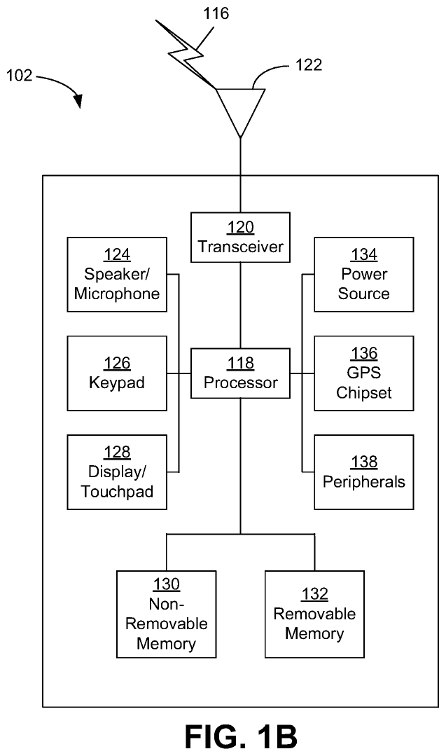

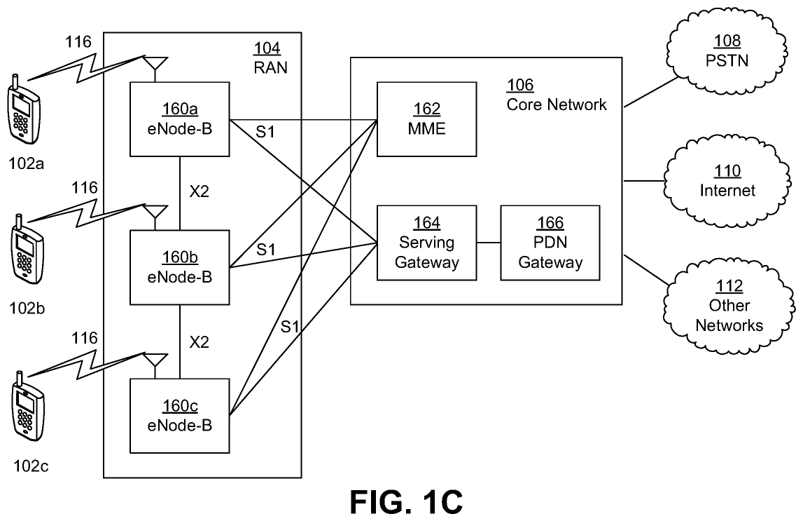

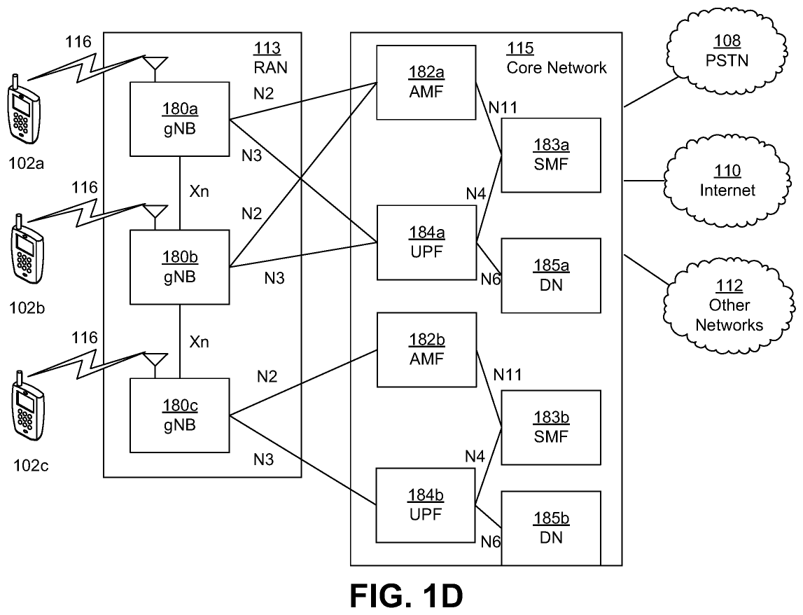

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with one or more of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHZ. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include one or more AMF 182a, 182b, one or more UPF 184a, 184b, one or more Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Personal IoT Network (PIN) Element (PINE) and PINE may be used interchangeably herein. A PINE may be a device that connects to a personal IoT network (PIN). PIN GW and PINE with gateway capability (PEGC) may be used interchangeably herein. A PEGC may be a PINE that is capable of acting as a gateway in the PIN. PIN management and PEMC may be used interchangeably herein. A PEMC may be a PINE that is capable of acting as a management function in the PIN. A device may be both a PEGC and a PEMC (e.g., may include features of both PEGC and PEMC as described herein). A device such as a plain pin element (PINE), PINE with gateway capabilities (PEGC), and/or PINE with management capabilities (PEMC) may be linked to a WTRU subscription. Linking a device to a WTRU's subscription may mean that the WTRU's subscription is updated to indicate that a plain PINE may be associated with that WTRU within a PIN. For example, if the WTRU is a PEMC or a PEGC, linking may indicate that the device (e.g., PINE) may operate within the PIN that is served by the PEMC or PEGC. As described herein, PINE may denote plain PINE (e.g., PINE that is not PEGC or PEMC). As disclosed herein, a WTRU may be and/or may comprise a PINE, a PEGC, a PEMC, and/or the like. In this document, the terms PEGC and PIN GW are used interchangeably. Also, the functions that are described as begin performed by a PEGC may be performed by a PEMC.

The Internet of Things (IoT) is designed to accommodate devices that communicate using a network. The network may be a cellular network. Devices with IoT capabilities may utilize increased power consuming performance and/or increased network efficiency for bulk operations. Devices with IoT capabilities may utilize increased power consuming performance and/or increased network efficiency for bulk operations depending on a deployment scenario.

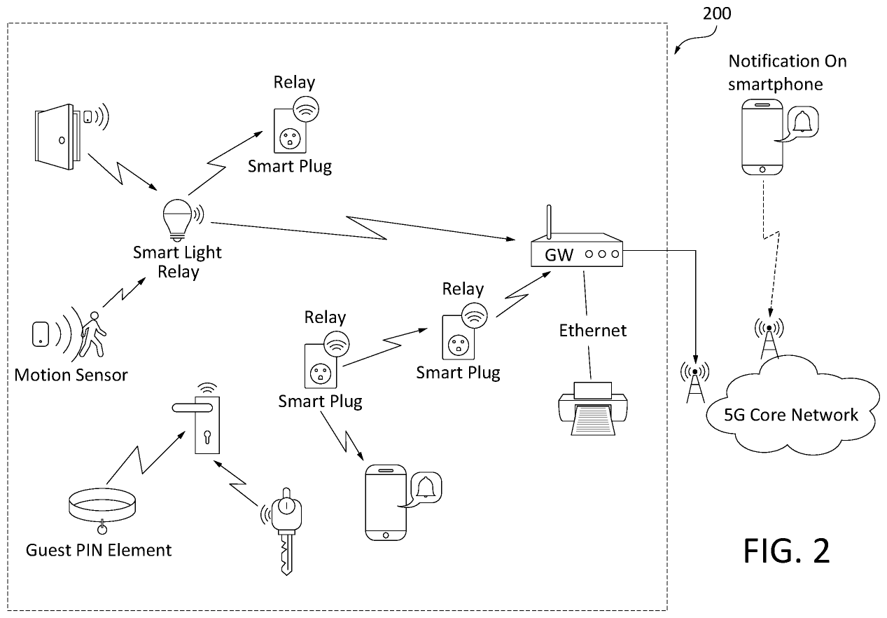

FIG. 2 depicts an example home automation Personal IoT Network (PIN) 200. One or more WTRUs with IoT capabilities may be organized in the PIN 200. For example, when multiple IoT devices are deployed in a private environment, the WTRUs with IoT capabilities may be organized in the PIN 200. In some embodiments, a security sensor, a smart light, a smart plug, a printer, a cellphone, etc. may be managed by a residential gateway and/or may communicate with each other. The residential gateway may be in a home environment. For example, IoT devices in a home environment may constitute the PIN 200. Each IoT device may be a PIN element and/or different PIN elements may have different capabilities. For example, a residential gateway may be a PIN element and/or have Gateway Capability (PIN GW). A PIN GW may be a PIN element that may provide one or more connections between PIN elements and/or connections between a core (e.g., 5G) network and/or PIN elements. A PIN element with Management Capability (PIN Mgmt) may be a PIN element that is configured to provide a means for an authorized administrator to configure and/or manage the PIN 200 (e.g., a residential gateway which is acting as a PIN GW may support a PIN management function as well and/or be a PIN element with management capability).

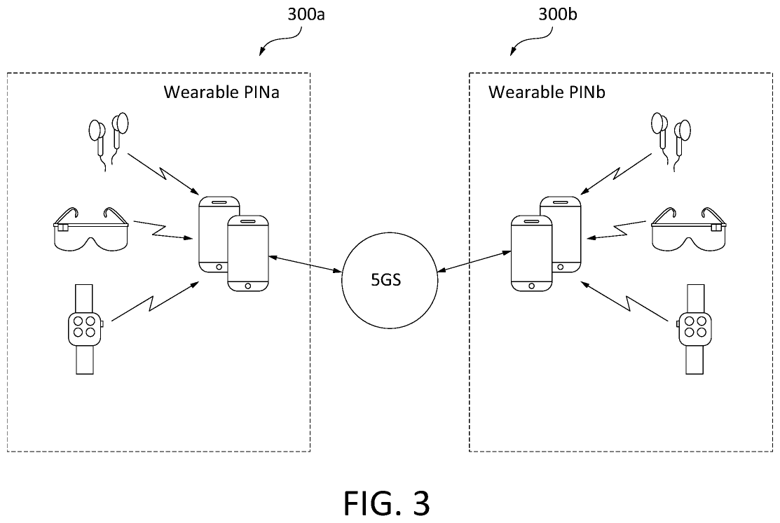

FIG. 3 depicts example wearable PINs 300a, 300b. One or more wearable devices may be organized into another kind of PIN (e.g., the wearable PIN 300a or the wearable PIN 300b). In some embodiments, a smart phone may be a PIN GW and/or a PIN Mgmt. The wearable devices (e.g., such as a smart watch, VR/AR glasses, headphones, etc.) may communicate with each other in the PIN and/or with other WTRUs via the core (e.g., 5G) network.

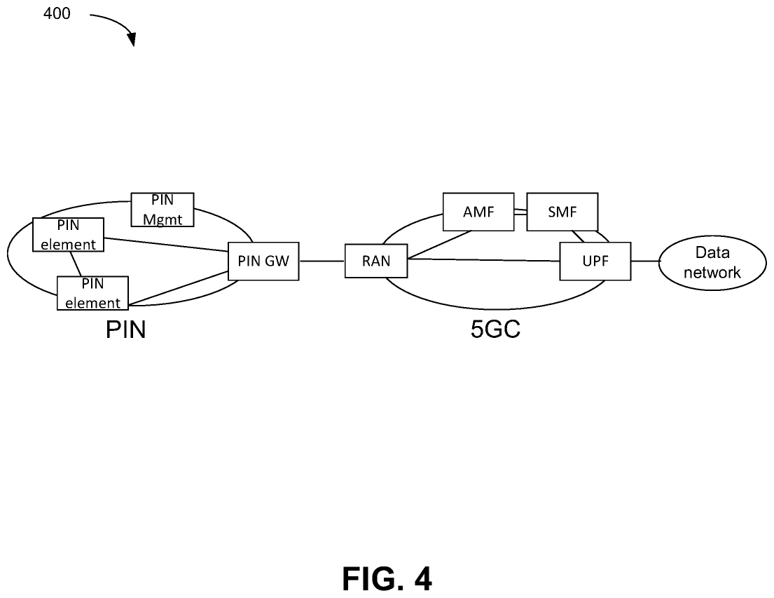

FIG. 4 depicts an example PIN architecture 400. A PIN may include one or more PIN Elements, and/or one or more PIN Mgmt devices, and/or one or more PIN GWs. A PIN element may be a WTRU and/or non-3GPP device that can communicate within a PIN, for example. A PIN Mgmt device may be a PIN element with a capability to manage the PIN. A PIN GW may be a PIN element that is configured to provide connectivity to and/or from the core (e.g., 5G) network for other PIN elements, for example.

PIN elements may communicate with each other via the PIN GW and/or directly. PIN elements may communicate with the core (e.g., 5G) network system. PIN elements may communicate with the core network system to obtain core (e.g., 5G) network services and/or communicate with a data network via the core (e.g., 5G) network.

PIN Mgmt devices and/or PIN GWs may be WTRUs. In some embodiments, other (e.g., some, or all, or all other) communications within the PIN may be carried out via non-3gpp communication (e.g., WiFi, Bluetooth, etc.). For example, PIN Mgmt WTRU may be used herein to represent a PIN Mgmt device. Although the examples herein are described as PIN Mgmt WTRUs, it should be appreciated that other devices (e.g., such as a non-3GPP device) could be used as the PIN Mgmt WTRUs described herein.

Proximity Services (ProSe) are services that may be provided based on WTRUs being in proximity to each other. To provide ProSe, WTRUs may perform a ProSe discovery procedure. The ProSe discovery procedure may be to discover other WTRUs in proximity.

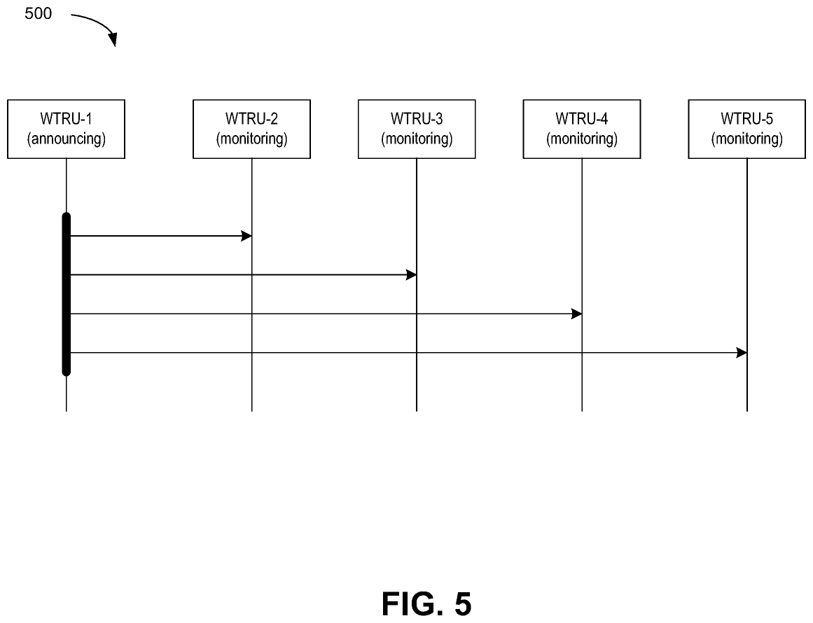

FIG. 5 depicts an example ProSe discovery mode 500. In ProSe discovery mode 500, a WTRU (e.g., the announcing WTRU) may broadcast one or more announcement messages. The one or more announcement messages may be announced with a ProSe code. For example, the ProSe code may be associated with the announcing WTRU's ID and/or associated with a service provided by the announcing WTRU. Other WTRUs who received the one or more announcement messages (e.g., a Monitoring WTRU) may know that the Announcing WTRU is in proximity.

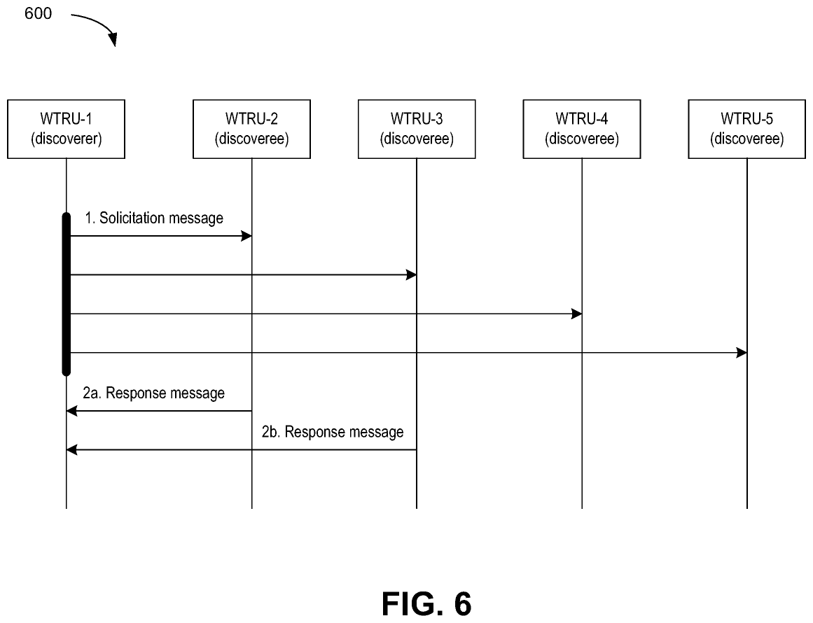

FIG. 6 depicts another example ProSe discovery mode 600. In the other example ProSe discovery mode 600, a WTRU (e.g., the discoverer WTRU) may broadcast one or more solicitation request messages. The one or more solicitation messages may be broadcast with a ProSe Query code. The ProSe Query code may be associated with one or more WTRU IDs to be discovered and/or associated with one or more ProSe service to be discovered. Other WTRUs who received the one or more solicitation request messages (e.g., the discoveree WTRUs) may respond to the request with a ProSe response code. The ProSe response code may be associated with the discoveree WTRUs ID and/or associated with the ProSe service provided by the discoveree WTRU. The discoverer WTRU may determine that the discoveree WTRU is in proximity, for example, based on receipt of the ProSe response code.

In some embodiments, one or more ProSe discovery modes 500, 600 may be used to perform Group discovery (e.g., to discover WTRUs which belong to a specific group) and/or WTRU-to-Network relay discovery (e.g., to discover a WTRU-to-Network relay which provide connection with the core network).

A discovery message(s) (e.g., Announcement, Solicitation Request/Response) may also include a Group ID. For WTRU-to-Network relay discovery, the discovery message(s) (e.g., Announcement, Solicitation Request/Response) may use a Relay Service Code (e.g., instead of a ProSe code) to indicate WTRU-to-Network relay service. The discovery message(s) may be for Group discovery, for example.

A PIN may include a plurality of different PIN elements (e.g., such as sensors, AR/VR, smart TV, etc.). The PIN elements may have different requirements. For example, the PIN elements may require access to different core networks' services. The PIN elements may use different PIN GWs to communicate with the respective/supporting core networks. The PIN elements may use different PIN GWs to communicate with the respective/supporting core networks to access differentiated services.

A PIN Mgmt WTRU may consider and/or otherwise utilize PIN element types, connectivity & QoS requirements, etc., for example, when selecting a PIN GW to ensure PIN elements are connected to their respective core networks and/or meet QoS requirements. The PIN Mgmt WTRU may discover the PIN GW devices that are available in the PIN. The PIN Mgmt WTRU may select a PIN GW that the PIN Mgmt WTRU may use, for example, to access the services of the core network. The PIN Mgmt WTRU may prioritize one PIN GW over one or more other PIN GW(s), for example, when selecting a PIN GW.

The PIN Mgmt WTRU may facilitate a PIN element discovering and/or selecting a PIN GW. The PIN element may use the PIN GW to access the services of the 5G System, for example.

A PIN may facilitate a plurality of PEGCs and/or a plurality of PEMCs as part of the PIN. The PIN may facilitate one or more of addition, removal, primary, secondary, redundancy planning, and etc.

A PIN Mgmt WTRU may select appropriate PIN GWs for each PIN element connected to its PIN. For example, a PIN Mgmt WTRU may select appropriate PIN GWs for one or more PIN element connected to a PIN. The PIN Mgmt WTRU may be configured with one or more policy parameters. Policy parameters may enable the selection of the appropriate PIN GWs. The PIN Mgmt WTRU may receive the policy parameters from the core network and/or from the PIN elements.

A PIN may have several PIN elements. The PIN elements may have different characteristics, for example, such as wearable devices, home automation devices, in the office or smart industrial automation devices, etc. Each of the PIN elements may have different requirements and/or roles. The different requirements and/or roles may be, for example, in terms of size, weight, power consumption, mission critical, high bandwidth, etc. A PIN Mgmt WTRU may create (e.g., based on the characteristics and/or requirements) a PIN with all or a subset of the PIN elements. Each PIN may include one or more PIN GWs available.

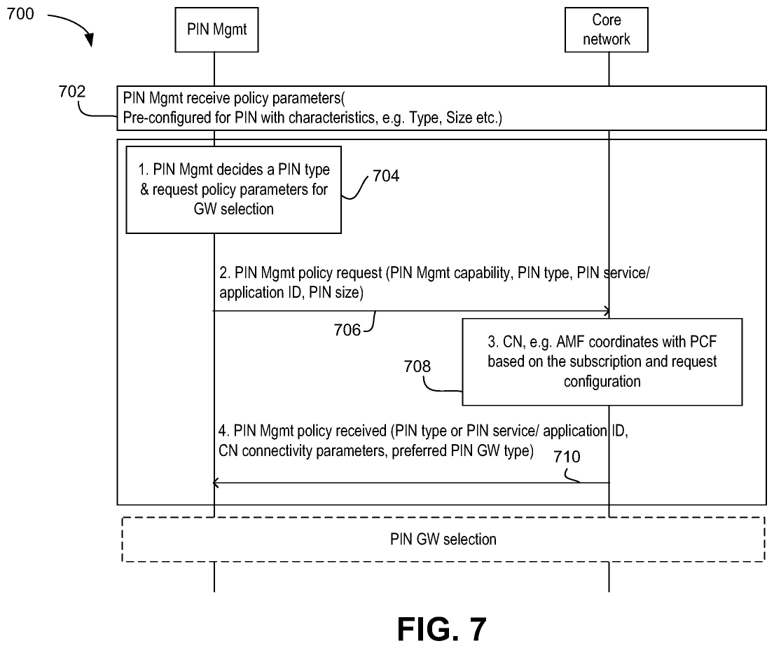

FIG. 7 depicts an example process 700 for PIN policy configuration. A WTRU (e.g., a PIN Mgmt WTRU or a PIN GW) may receive direct discovery related parameters such as discovery code, discovery filters, and/or WTRU ID from the Direct Discovery Name Management Function (DDNMF), for example, when the PIN Mgmt WTRU and a PIN GW are capable of PC5 communication.

PIN element characteristics (e.g., such as PIN Types supported, CN Connectivity, Power source, QoS support, network slice) and/or or PIN element type (Sensor Type, AR/VR, smart light, plug, WTRU etc.) may be utilized. PIN Mgmt could be configured with policy parameters for PIN element characteristics and/or PIN element type. For example, PIN Mgmt could be configured with policy parameters for PIN element characteristics and/or PIN element type to make selection of a most appropriate PIN GW. The PIN

GWs (e.g., the most appropriate PIN GWs) may be preconfigured in the PIN Mgmt WTRU. In some embodiments, the preconfiguration may be at the application layer. The PIN Mgmt WTRU may receive the policy parameters from the core network. The receipt of the policy parameters may be as part of an initial registration. For example, receipt of the policy parameters may be based on a PIN management capability indication. In some embodiments, the PIN management capability indication may be in a Registration Request message. The PIN Mgmt WTRU may be configured to send the Registration Request message. The PIN Mgmt WTRU may be configured to send the Registration Request message to the core network. The PIN Mgmt WTRU may be configured to send the Registration Request message during the initial registration.

Additionally or alternatively, the PIN Mgmt WTRU (e.g., WTRU initiated), may request policy parameter(s). For example, the WTRU may request policy parameters based on the potential PIN element type according to the characteristics of PIN elements. The PIN Mgmt WTRU may request and/or receive data from active PIN elements. The PIN elements may be connected to the PIN served by the PIN Mgmt WTRU, for example, to identify PIN element characteristics before requesting parameters from the core network for appropriate PIN GW selection.

The PIN Mgmt WTRU may receive the policy parameters in a plurality of different manners. In some embodiments, a PIN Mgmt WTRU may receive the policy parameters from the core network (e.g., from policy control function (PCF) it has already indicated PIN Mgmt capabilities to the core network) at 702. The policy parameters may include pre-configuration for one or more PIN elements. For example, the pre-configuration information may include one or more PIN element characteristics. For example, the characteristics may be type size and/or preferred PIN gateway for that PIN element type.

In some embodiments, the PIN Mgmt WTRU may receive a connection request. The PIN Mgmt WTRU may determine a PIN type and/or request policy parameters for GW selection at 704. For example, the connection request may be from one or more PIN elements. The PIN Mgmt WTRU may select an appropriate PIN GW for connection establishment. For example, the PIN Mgmt may determine a PIN element type based on the PIN element characteristics. The PIN Mgmt WTRU may send a policy parameter request. The policy parameter request may be to the core network at 706. The PIN Mgmt WTRU may include a PIN Mgmt capability, the determined PIN element type, a PIN service and/or application ID, and/or a PIN size in the policy parameter request.

Additionally or alternatively, the PIN Mgmt WTRU and/or PIN GW may receive a discovery code(s) and/or discovery filter(s). The discovery code(s) and/or discovery filter(s) may be related to PIN GW discovery. For example, the discovery code(s) and/or discovery filter(s) may be related to when the PIN Mgmt WTRU and/or the PIN GW are capable of PC5 communication. The discovery code(s) and/or discovery filter(s) may include one or more of PIN element types supported, PLMN ID of respective WTRU(s), etc. The core network (e.g., an AMF at the core network) may coordinate with PCF. The coordination may be based on the policy parameter request (e.g., subscription and request configuration) at 708.

At 710, the PIN Mgmt WTRU may receive a policy response. The policy response may be received from the core network. The policy response may include one or more of a PIN type, a PIN service and/or application ID, a preferred PIN GW, a preferred PIN GW type, and/or CN connectivity parameters.

The PIN Mgmt WTRU may generate a list of available PIN GWs. The list may be generated on a PIN. The PIN Mgmt WTRU may receive messages. The messages may be received from one or more available PIN GWs on the PIN. The messages from the available PIN GWs may be pushed (e.g., without a request from the PIN Mgmt WTRU) and/or pulled (e.g., sent in response to a request from the PIN Mgmt WTRU).

A PIN element with gateway capability (e.g., a PIN GW) may broadcast one or more announcement messages. The announcement messages may include PIN element ID(s) and/or PIN element information. The PIN element information may include one or more of whether the PIN element is a PIN GW, one or more PIN capabilities, and/or a Core Network identifier. For example, the announcement message may include one or more of an identifier of the PIN GW, a Network ID that may indicate what network the PIN GW can provide connectivity to, an indication that the device is a PIN GW, and/or an indication of one or more capabilities of the PIN GW. The Network ID may be a PLMN ID. The indication of one or more capabilities of the PIN GW may be a bit string and/or a service code. The PIN Mgmt may use the bit string and/or service code to determine the one or more capabilities of the PIN GW. The one or more capabilities of the PIN GW may include relative data rates. In some embodiments, data rates may be obtained when communicating via the PIN GW, whether the PIN GW is battery powered, and/or whether the PIN GW is a mobile device.

A PIN element with management capabilities (e.g., a PIN Mgmt WTRU) may discover available PIN GWs after receiving one or more announcement messages. The PIN Mgmt WTRU may consider the information that was received in the announcement messages received from each PIN GW. The PIN Mgmt WTRU may prepare a list of available PIN GWs, for example, based on the information received in the announcement messages. The list of available PIN GWs and/or the information received in the announcement messages may be used in a PIN GW prioritization and/or selection process.

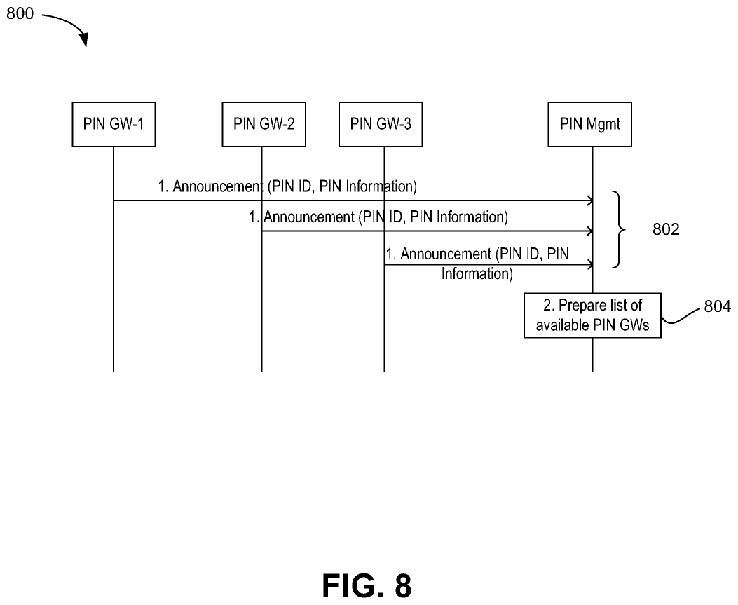

FIG. 8 depicts an example process 800 of PIN GW discovery. The At 802, the PIN Mgmt WTRU may receive the announcement messages coming in from PIN GWs (e.g., PIN GW-1, PIN GW-2, and PIN GW-3). At 804, the PIN Mgmt WTRU mayand generate the list of available PIN GWs (e.g., based on the announcement messages received from the various PIN GWs). The list of available PIN GWs may indicate capabilities and/or supported features associated with each of the PIN GWs (e.g., as described in Table 1, herein).

PIN information may include one or more of the following information elements, depending on PIN element type and/or capabilities supported. Table 1 depicts example PIN element information that may be stored in the list of available PIN GWs.

TABLE 1
PIN Element Information

| Information ID | Description |
|---|---|
| PIN ID | Unique PIN Identifier |
| PIN Capability | PIN element is a normal PIN element, |
| | or it's a PIN element with either |
| | Management or Gateway capabilities |
| PIN Types | Sensor Type, AR/VR, smart light, |
| supported | plug, WTRU, etc. |
| Quality of | QoS supported (high/low bandwidth) |
| Service (QOS) | |
| CN | Core Network connectivity and |
| Connectivity | identifier (e.g., PLMN ID) |
| Network Slice | Information on the network slice |
| support | support (e.g., S-NSSAI/NSSAI |
| Power Source | Battery operated (e.g., yes/no) |

A PIN Mgmt WTRU may send (e.g., broadcast) a solicitation request message. The solicitation request message may indicate a desired PIN element type to be discovered. The PIN element type indication may indicate that PIN elements with Gateway capabilities should respond back with further details. The solicitation request message may be intended for any PIN GW that supports desired functionality. The PIN Mgmt WTRU may indicate one or more requested (e.g., desired) functionalities of the PIN GW. The PIN Mgmt WTRU may indicate one or more requested (e.g., desired) functionalities of the PIN GW by including an indication of the one or more requested capabilities of the PIN GW in the solicitation request message. The indication of the one or more desired capabilities may be a bit string and/or a service code. The PIN GW(s) may determine the one or more capabilities that the PIN Mgmt WTRU is requesting based on the indication. The indication may indicate information. The information may include one or more of, for example, the relative data rates that may be obtained when communicating via the PIN GW, whether the PIN GW is battery powered, and/or whether the PIN GW is a mobile device. The solicitation request message may indicate what PLMN(s) the PIN Mgmt WTRU is associated with. The solicitation request message may include the identity of the specific PIN (e.g., PIN ID). For example, the solicitation request message may include the identity of the specific PIN (e.g., PIN ID) when the PIN Mgmt WTRU is attempting to discover a PIN GW that is associated with a specific PIN.

PIN GWs that receive the solicitation request message may send a solicitation response along with PIN information (e.g., as shown in Table 1) to the PIN Mgmt WTRU. The PIN GW may use the information from the solicitation request message to determine whether to send a solicitation response.

The PIN Mgmt WTRU may monitor the solicitation responses and/or accordingly build the list of available PIN GWs. The list of available PIN GWs may be used in a PIN GW prioritization & selection process.

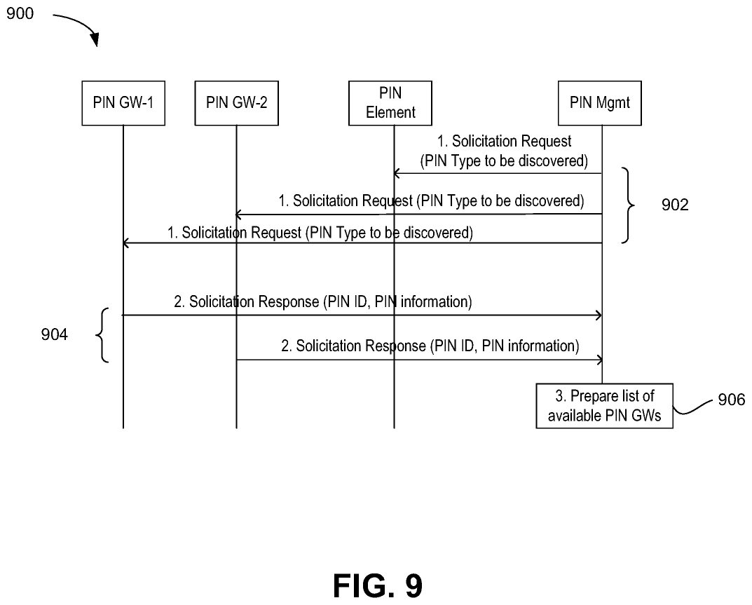

FIG. 9 depicts another example process 900 of PIN GW discovery. At 902, the PIN Mgmt WTRU may send (e.g., broadcasts) the solicitation request message to one or more PIN elements (e.g., a first PIN GW-1, a second PIN GW-2, a PIN element, etc.). The solicitation request message may include one or more PIN types to be discovered. In some embodiments, the PIN Mgmt WTRU may be searching for available PIN GWs.

At 904, the PIN Mgmt WTRU may receive a solicitation response from one or more PIN GWs. For instance, one or more PIN GWs may respond to the solicitation request message. The one or more PIN GWs may respond to the solicitation request message with a solicitation response. The solicitation response may include a PIN ID associated with the PIN GW and/or PIN information (e.g., as shown in Table 1) associated with the PIN GW. Other PIN elements (e.g., non-PIN GWs) may ignore the solicitation request message from the PIN Mgmt WTRU.

The PIN Mgmt WTRU may receive the solicitation response messages. Solicitation response messages may come in from the one or more PIN GWs. At 906, the PIN Mgmt WTRU may build a list of available PIN GWs along with their capabilities and/or supported features based on the solicitation response messages (e.g., suing the information included within the solicitation response messages, such as that shown in Table 1).

In some examples, the PIN Mgmt WTRU may send a registration request to the core network. The core network may send a prioritized list of available PIN GWs at the present location (e.g., of the PIN Mgmt WTRU). The core network may send a prioritized list of available PIN GWs at the present location (e.g., of the PIN Mgmt WTRU) along with related PIN Information (e.g., as shown in Table 1). In such examples, the PIN Mgmt WTRU may receive the prioritized list of available PIN GWs from the core network (e.g., “Network controlled prioritized list of PIN GWs”).

In some examples, the “Network controlled prioritized list of PIN GWs” list may be provisioned within the PIN Mgmt WTRU. The “Network controlled prioritized list of PIN GWs” list may be provisioned within the PIN Mgmt WTRU during the configuration phase. The “Network controlled prioritized list of PIN GWs” list may be received by the PIN Mgmt WTRU via NAS signaling (e.g., SoR, Configuration Update Command etc.). The “Network controlled prioritized list of PIN GWs” list may be received by the PIN Mgmt WTRU via NAS signaling (e.g., SoR, Configuration Update Command etc.) without an explicit trigger from the PIN Mgmt WTRU. A combined (e.g., User-controlled and Network-controlled) prioritized list of PIN GWs may be used in the PIN GW prioritization and/or selection processes.

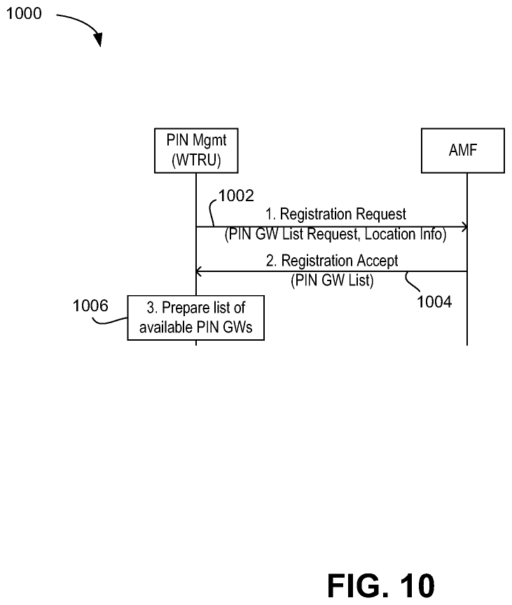

FIG. 10 depicts an example process 1000 for the PIN Mgmt WTRU to request a list of PIN GWs from the core network. At 1002, the PIN Mgmt WTRU may send a registration request message to the AMF. The registration request message may be used to request a prioritized list of PIN GWs for the current location. The registration request message may be a configuration update command to deliver a PIN GW priority list to the PIN Mgmt WTRU. The registration request message may not be limited to a NAS registration message. In some embodiments, the registration request message could be sent via any WTRU triggered NAS signaling (e.g., such as Registration/Mobility Registration/Periodic registration/Service Request, etc.). For example, the core network could send the prioritized list of PIN GWs via any network trigger NAS signaling (e.g., such as Steering of Roaming container, Configuration Update Command, etc.) and/or as a response to a WTRU triggered request.

At 1004, the PIN Mgmt WTRU may receive a registration accept message from the AMF. For example, the AMF may respond to the registration request message with the registration accept message. The registration accept message may include a prioritized list of PIN GWs (e.g., “Network controlled prioritized list of PIN GWs” and along with the PIN GW capabilities). The content of the registration accept message may be carried in response to a service request and/or any other NAS message.

The serving AMF may use the location information provided by the WTRU to query other AMFs to provide a prioritized list of PIN GWs for the requested location. This may, for example, yield a consolidated prioritized list of PIN GWs belonging to different AMFs. In some embodiments, the serving AMF may send the consolidated prioritized list of PIN GWs to the requesting WTRU (e.g., the PIN Mgmt WTRU).

At 1006, the PIN Mgmt WTRU may generate a list of available PIN GWs along with their capabilities and supported features as received from the AMF. The PIN Mgmt WTRU may send the list of available PIN GWs and their capabilities and supported features to the PIN GW prioritization and/or selection process.

In some examples, a PIN Mgmt WTRU may request from and/or may be pre-configured by an authorized third party and/or a customer of a public network operator to provide the prioritized list of available PIN GWs. The PIN GWs may be at the present location along with related PIN Information (e.g., as shown in Table 1).

In some embodiments, the PIN Mgmt WTRU may have the prioritized list of available PIN GWs from the authorized third party and/or customer (e.g., “User controlled prioritized list of PIN GWs”).

In some embodiments, the “User-controlled prioritized list of PIN GWs” list may be provided within the PIN Mgmt WTRU during the configuration phase and/or later to the PIN Mgmt WTRU. For example, a “User-controlled prioritized list of PIN GWs” list may be provided within the PIN Mgmt WTRU during the configuration phase and/or later to the PIN Mgmt WTRU via a portal provided by a public network operator.

In some embodiments, the combined prioritized list of PIN GWs may be fed into the PIN GW prioritization & selection process.

In some embodiments, a PIN element may perform a PIN GW discovery procedure. The PIN element may report available PIN GWs to the PIN Mgmt WTRU. The PIN Mgmt WTRU may receive the available PIN GWs from one or more PIN element. The PIN Mgmt WTRU may select PIN GW(s) for the PIN element based on the received available PIN GWs from one or more PIN element.

The PIN Mgmt WTRU may select PIN GWs based on a combination of received available PIN GWs from one or more PIN element and/or available PIN GWs discovered by the PIN Mgmt WTRU. The PIN Mgmt WTRU may additionally or alternatively take User-controlled and/or Network-controlled prioritized lists of PIN GWs into account when selecting PIN GWs.

The PIN element may report identifier(s) of available PIN GWs to the PIN Mgmt WTRU. The PIN element may report identifier(s) of available PIN GWs to the PIN Mgmt WTRU, for example, during and/or after the establishment of connection between the PIN element and the PIN Mgmt WTRU.

In some embodiments, the PIN element may broadcast available PIN GWs in discovery message and/or the PIN Mgmt may receive available PIN GWs of one or more PIN elements via discovery message.

The PIN element may determine available PIN GWs based on the discovered PIN GWs and/or the PIN element's policy. For example, the discovered (e.g., only discovered) PIN GWs that satisfy the PIN elements policy (e.g., for a specific PIN type, for a specific PLMN) may be provided to the PIN Mgmt WTRU.

The PIN Mgmt WTRU may select one or more PIN GWs for the PIN. The PIN Mgmt WTRU may select a PIN GW for each PIN element.

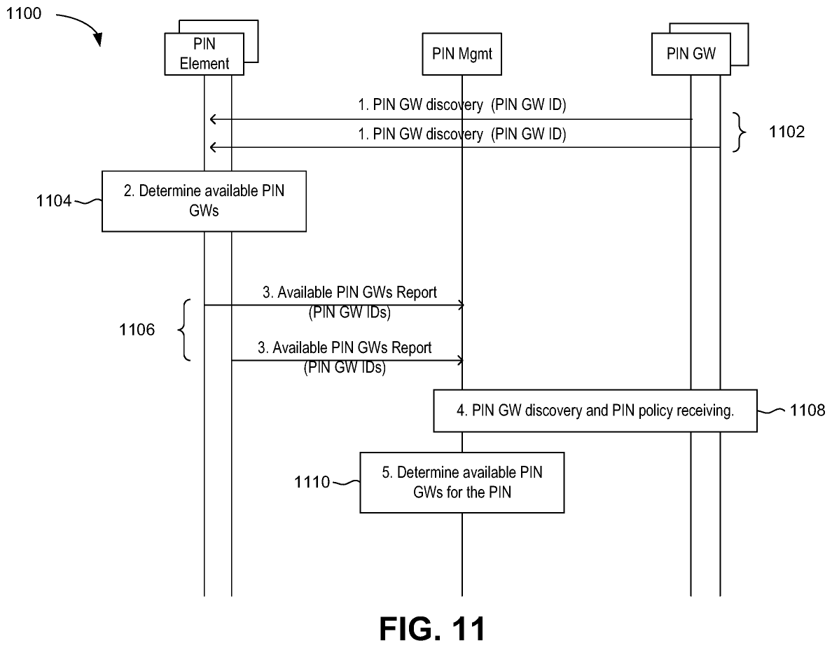

FIG. 11 depicts an example process 1100 for PIN GW selection based on available PIN GW from each PIN element. At 1102, each PIN element may discover available PIN GWs. For example, each PIN element may receive discovery messages from each available PIN GW. The discovery messages may include a PIN GW ID. The PIN GW ID may be associated with the respective available PIN GW. At 1104, each PIN element may determine the available PIN GWs based on the discovered PIN GWs and/or local policy. At 1106, each PIN element may provide the available PIN GWs to the PIN Mgmt WTRU. The available PIN GWs may be broadcasted (e.g., by discovery message) and/or reported to the PIN Mgmt WTRU. For example, the available PIN GWs may be broadcasted (e.g., by discovery message) and/or reported to the PIN Mgmt WTRU via a report message, for example.

At 1108, the PIN Mgmt WTRU may perform PIN GW discovery and receive a PIN GW selection policy. At 1110, the PIN Mgmt WTRU may determine the available PIN GWs for the PIN and/or select PIN GWs for the PIN and/or for each PIN elements.

A PIN Mgmt WTRU (e.g., a WTRU) may use list of available PIN GWs at a particular location to select a PIN GW. For example, a PIN Mgmt WTRU (e.g., a WTRU) may use list of available PIN GWs at a particular location to select a PIN GW to create the PIN. The PIN Mgmt WTRU may select the PIN GW based on the PIN elements in the PIN and/or their requirements. The PIN Mgmt WTRU may prioritize a list of PIN GWs. For example, the PIN Mgmt WTRU may prioritize a list of PIN GWs before selecting the PIN GW to create the PIN.

In some embodiments, the PIN Mgmt WTRU may use a list of available PIN GWs at a particular location and/or other criteria to select a PIN GW for creation of the PIN. The other criteria may include one or more of, for example, PIN characteristics, PIN requirements, PIN GW capabilities, etc.

The PIN may be created when a PIN Mgmt WTRU is authorized to manage/create a PIN that did not previously exist. Authorization may come from the core network, for example. A PIN may have one or more PIN GWs and/or one or more PIN Mgmt WTRUs.

In some embodiments, the PIN Mgmt WTRU may receive and/or generate a list of available PIN GWs. For example, the PIN Mgmt WTRU may receive and/or generate a list of available PIN GWs along with characteristics (e.g., PIN GW ID, Capabilities, PIN Types supported, QoS support, 5G Core Network identifier, etc.).

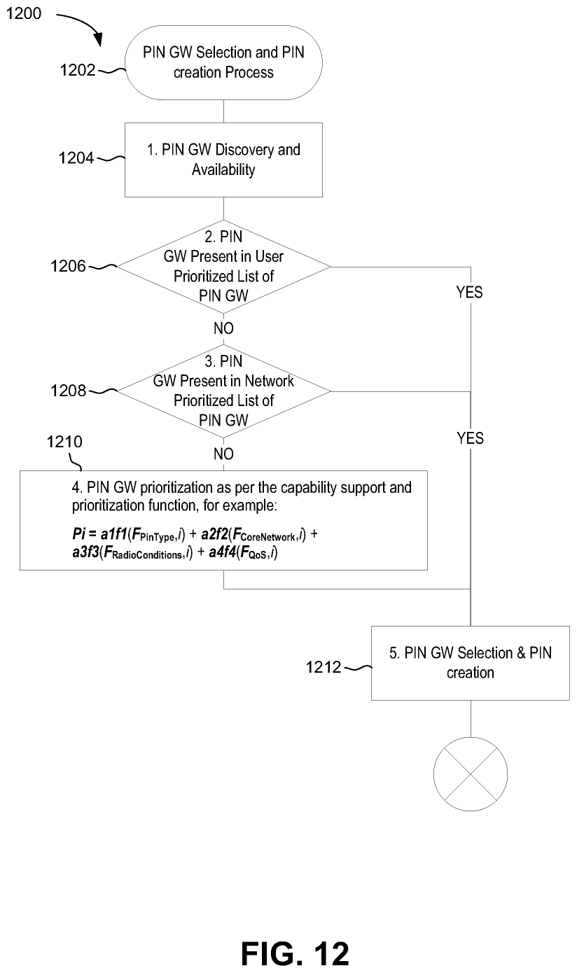

FIG. 12 depicts an example process 1200 for PIN GW selection and/or PIN creation. At 1202, the PIN Mgmt WTRU may perform a PIN GW prioritization and selection process. The PIN GW prioritization and selection process may be used to set up the PIN as per the PIN elements and/or requirements. The example process 1200 shown in FIG. 12 may be executed by the PIN Mgmt WTRU.

At 1204, the PIN Mgmt WTRU may build a list of available PIN GWs. For example, the PIN Mgmt WTRU may build a list of available PIN GWs along with characteristics using the methods described herein (e.g., either using local discovery using proximity services or getting assistance information from the core network). The PIN Mgmt WTRU may store PIN Information. For example, PIN information may include one or more of the information shown in Table 1 (e.g., such as PIN GW ID, QoS supported, PIN Types Supported, 5G Core network identifier, network slice supported, etc.).

The PIN Mgmt WTRU and/or PIN elements may be pre-configured with preferred PIN GWs (e.g., a User controlled prioritized list of preferred PIN GWs). At 1206, the PIN Mgmt WTRU may determine whether a PIN GW from the list of available PIN GWs is present in the User controlled prioritized list of preferred PIN GWs. If the PIN Mgmt WTRU determines that a PIN GW from the list of available PIN GWs is present in the User controlled prioritized list of preferred PIN GWs, then the PIN Mgmt WTRU may select a PIN GW from the list of User controlled prioritized list of preferred PIN GWs at 1212. For example, the PIN Mgmt WTRU may select the highest priority PIN GW as per the User-controlled prioritized list of preferred PIN GWs which is available to form the PIN. For example, when the preferred PIN GWs are pre-configured and a user preferred PIN GW is available (e.g., part of the list of available PIN GWs), the PIN Mgmt WTRU may select the highest priority PIN GW as per the User-controlled prioritized list of preferred PIN GWs which is available to form the PIN. In some embodiments, the PIN Mgmt WTRU may select the next available highest priority entry from the User controlled prioritized list of preferred PIN GWs and/or proceed with PIN GW selection and/or PIN creation. For example, if the PIN GW selection fails, the PIN Mgmt WTRU may select the next available highest priority entry from the User controlled prioritized list of preferred PIN GWs and/or proceed with PIN GW selection and/or PIN creation.

If the PIN Mgmt WTRU determines that a PIN GW from the list of available PIN GWs is not present in the User controlled prioritized list of preferred PIN GWs at 1208, the PIN Mgmt WTRU may determine whether a PIN GW from the list of available PIN GWs is present in a Network-controlled prioritized list of PIN GWs provided by the core network at 1208. If the PIN Mgmt WTRU determines that a PIN GW from the list of available PIN GWs is present in the Network controlled prioritized list of preferred PIN GWs, then the PIN Mgmt WTRU may select a PIN GW from the list of Network controlled prioritized list of preferred PIN GWs at 1212.

If the PIN Mgmt WTRU determines that a PIN GW from the list of available PIN GWs is not present in the Network controlled prioritized list of preferred PIN GWs at 1208, then the PIN Mgmt WTRU may select a PIN GW based on capability support and/or a prioritization function at 1210. For example, when the User-controlled prioritized list of preferred PIN GWs is not configured in the PIN elements/PIN Mgmt WTRU and/or available PIN GWs are not part of the list, the PIN Mgmt WTRU may check if a list of available PIN GWs is present in the Network-controlled prioritized list of PIN GWs provided by the core network. In some embodiments, the PIN Mgmt WTRU may proceed with PIN GW selection and/or PIN creation in the prioritized way with first entry in the list that has the highest priority and matching PIN characteristics. For example, if the list of available PIN GWs is present, the PIN Mgmt WTRU may proceed with PIN GW selection and/or PIN creation in the prioritized way with first entry in the list that has the highest priority and matching PIN characteristics.

In some embodiments, the PIN Mgmt WTRU may use an internal policy which is the result of the function which considers PIN element requirements and/or tries to match them to available PIN GWs. For example, when neither the User-controlled prioritized list of preferred PIN GWs nor the Network-controlled prioritized list of PIN GWs is present or list of available PIN GWs are not part of these lists, the PIN Mgmt WTRU may use an internal policy which is the result of the function which considers PIN element requirements and/or tries to match them to available PIN GWs.

In some embodiments, the PIN Mgmt WTRU may pair together PIN elements with small data requirements (e.g., time insensitive smart sensors, small data requirements, latency is not an issue, etc.) with a PIN GW which supports small data requirements (e.g., Support smart sensor PIN Type, small data requirements, time insensitive network, etc.) to form the PIN.

In some embodiments, the PIN Mgmt WTRU may pair together PIN elements with high data usage (e.g., AR/VR equipment's, Smart TV (8 k streaming requirements)) with a PIN GW which supports high data usage (e.g., High bandwidth, eMBB support, etc.).

In some embodiments, the PIN Mgmt WTRU may pair together PIN elements with time sensitive data with a PIN GW which supports time sensitive date (e.g., eURLLC support, low latency communication, etc.).

In some embodiments, one or more algorithm to determine the priority of the PIN GW for selection and/or PIN creation (e.g., the prioritization algorithm) may include various utility functions. For example, utility functions may assess the value proposition of different information elements. Different utility functions and/or their weight may be used to prioritize the available PIN GWs.

In some embodiments, a PIN GW (i) and various utility functions (e.g., f₁ for PIN Type support, f₂ for ensuring PIN element may be connected to the desired core network, f₃ will take into consideration radio conditions, f₄ would take into consideration QoS requirements (high/low bandwidth, time sensitive/insensitive, etc.). A weighted sum of these utility functions and/or added weight (e.g., a₁, a₂ . . . a₄) may determine the overall priority of the PIN GW. An example algorithm used by the PIN Mgmt WTRU to determine the priority of the PIN GW for selection and/or PIN creation is shown in Equation (1).

$$Pi = a 1 f 1 ( {F}_{PinType} , i ) + a 2 f 2 ( {F}_{CoreNetwork} , i ) + a 3 f 3 ( {F}_{RadioConditions} , i ) + a 4 f 4 ( {F}_{QoS} , i ) \qquad ( 1 )$$

Equation (1) may represent a function that may be used to determine the priority of the PIN GW, wherein Pi would provide, for example, the overall priority for the given PIN GW.

In some embodiments, the PIN Mgmt WTRU may use the selected PIN GW to setup and/or create the PIN. In some embodiments, PEGC selection may be repeated, for example, until the (e.g., all) PINEs which are part of the PIN may be mapped/assigned to respective desired PEGCs. For example, if more than one PEGC is required to be part of the PIN (e.g., based on the PINEs and/or configuration), PEGC selection may be repeated, for example, until the (e.g., all) PINEs which are part of the PIN may be mapped/assigned to respective desired PEGCs. The PINEs may be mapped/assigned to the respective desired PEGCs based on one or more PIN characteristic requirements. Characteristic requirements may include, for example, such as PIN Type, QoS requirement, etc.

In some embodiments, the core network may generate the prioritized PIN GW list using a prioritization algorithm described herein. The core network may then send the prioritized PIN GW list to the PIN Mgmt WTRU. The prioritized PINM GW list may be sent, for example, via NAS signaling.

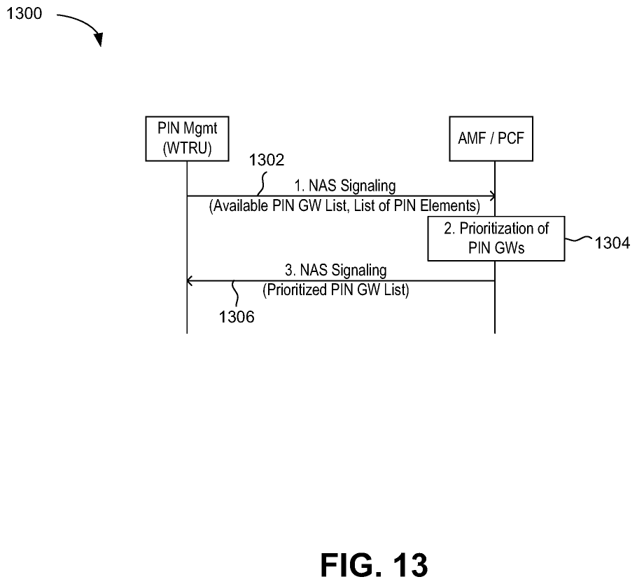

FIG. 13 depicts an example process 1300 for PIN GW prioritization. In some embodiments, the function (Pi) to determine the priority of the PIN GW may be offloaded by the PIN Mgmt entity to the core network (e.g., AMF/PCF). The PIN Mgmt WTRU may be capable of establishing direction connection with the core network and/or sharing required information with the AMF/PCF. At 1302, the PIN Mgmt WTRU may provide, to the core network, a list of available PIN GWs along with their capabilities and/or a list of PIN elements which would like to form the PIN. For example, the PIN Mgmt WTRU may share the list of available PIN GWs along with their characteristics and/or the list of PIN elements which would like to form the PIN via NAS signaling with the core network (e.g., AMF/PCF).

The core network (e.g., the AMF/PCF) may receive the information from the PIN Mgmt WTRU. At 1304, the core network may prioritize the PIN GWs as per a prioritization function. For example, the prioritized function may be (Pi) described herein (e.g., such as Equation 1). At 1306, the core network (e.g., the AMF/PCF) may send the prioritized list of PIN GWs to the PIN Mgmt WTRU.

In some embodiments, the exchange of information between the PIN Mgmt WTRU and the core network (e.g., the AMF/PCF) may be exchanged via the PIN GW. For example, the exchange of information between the PIN Mgmt WTRU and the core network (e.g., the AMF/PCF) may be exchanged via the PIN GW for the prioritization of the PIN GWs.

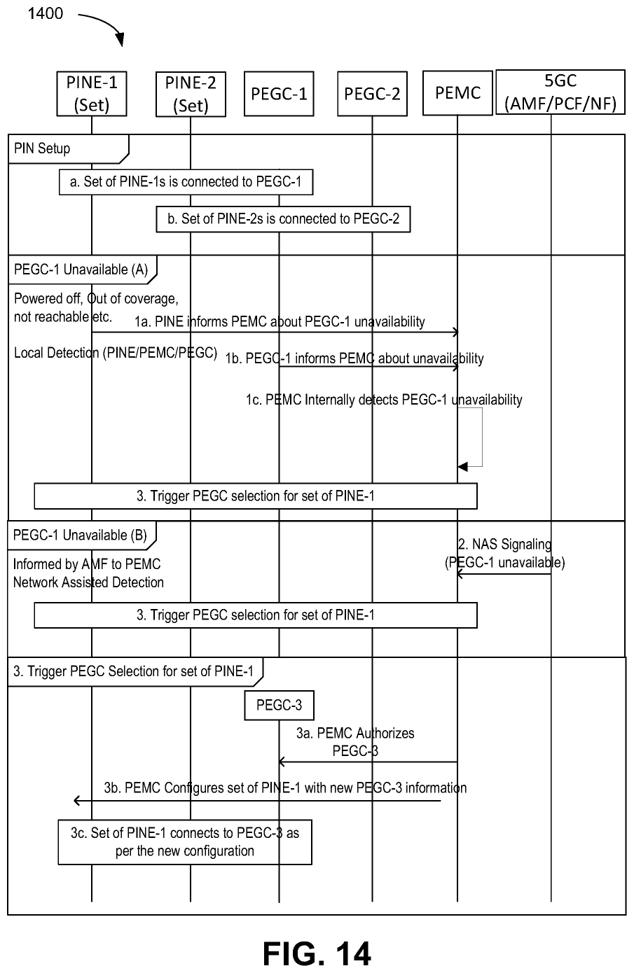

In some embodiments, a PIN may include one or more PIN elements with gateway capabilities (e.g., multiple PEGCs). FIG. 14 depicts an example process 1400 to change association between a PINE and a PEGC. As shown in FIG. 14, a PEGC may become unavailable and/or unsuitable. In some embodiments, the network may be configured to one or more of de-authorize the PIN element (e.g., WTRU) to operate as a PEGC, the PEGC may no longer be suitable to serve as a gateway for certain PINEs, and/or a change of PEGC user configuration may cause the PEGC to no longer be able to serve as a gateway for certain PINE(s). As shown in FIG. 14, the system may, for example, designate a new PEGC to serve as a gateway for a PINE. In some embodiments, the system may, for example, designate a new PEGC to serve as a gateway for a PINE when a PEGC serving the PINE becomes unsuitable (e.g., is no longer suitable).

In some embodiments, changing the association between a PINE and a PEGC may include PIN setup. A PIN may include a plurality of PEGCs and/or a PEMC, for example, as a precondition to PIN setup. A first set of PIN elements (e.g., PINE-1s) may be connected to a first PEGC (e.g., PEGC-1). A second set of PIN elements (e.g., PINE-2s) may be connected to a second PEGC (e.g., PEGC-2). The first set of PINEs and the second set of PINEs may include one or more PINEs. The description provided herein for one PINE may be repeated for each PINE in the set (e.g., the first set of PINEs and/or the second set of PINEs).

The first PEGC (e.g., PEGC-1) may be unavailable. The PIN may determine that the first PEGC is unavailable, for example, locally. The first PEGC may be unavailable when it is no longer able to serve as a gateway for one or more PINEs. A PINE and/or the PEGC may determine that the first PEGC is no longer able to serve as the gateway for one or more PINEs. For example, a first PINE (e.g., such as PINE-1) may determine that the first PEGC is no longer able to serve as the gateway for the first PINE.

In some embodiments, the first PINE may detect that the first PEGC is unavailable and/or not reachable. The first PINE may inform the PEMC that the first PEGC is unavailable and/or not reachable. The first PINE may inform the PEMC that the first PEGC is unavailable and/or not reachable when the first PINE determines that the first PEGC is no longer suitable for the PINEs in the first set of PINEs. The first PINE may determine that the first PEGC is no longer suitable if the first PEGC does not respond and/or acknowledge one or more requests from the first PINE during a predetermined time period. The first PINE may determine that the first PEGC is no longer suitable based on a percentage of first PINE requests that receive a response or acknowledgement from the first PEGC falling below a predetermined threshold. Additionally or alternatively, the first PINE may determine that first PEGC is no longer suitable based on the first PINE determining that a data rate measurement on the data the first PINE transmits via a first PEGC falling below a predetermined threshold. The first PINE may determine that the first PEGC is no longer suitable based on receipt of a message from the first PEGC, PEMC, and/or the network. The message may indicate that the first PEGC can no longer serve as the gateway for the first PINE and/or that a different PEGC should serve as the gateway for the first PINE.

The first PEGC may determine that it is unavailable and/or unreachable. The first PEGC may inform the PEMC about its unavailability. For example, the first PEGC may inform the PEMC that it is unavailable. The first PEGC may determine that it is unavailable and/or unreachable based on the first PEGC not wanting to serve the first set of PINEs, the first PEGC being gateway for one or more other PINEs, a change of setting on the WTRU (e.g., user changes GUI settings), and/or the first PEGC no longer being authorized to act as a gateway (e.g., de-authorized by the 5GC) and informs the same to PEMC. The first PEGC may determine to send an unavailable message to the PEMC based on a change to a user (e.g., GUI) setting. For example, the user setting may be used to configure the gateway to no longer act as a gateway for the first PINE. Additionally or alternatively, the first PEGC may determine to send the unavailable message based on determining that an amount of data and/or a rate of data (e.g., sent to/from the first PINE) has exceeded a predetermined threshold. For example, the first PEGC may determine that it is no longer suitable to serve as a gateway for the first PINE based on the first PINE not responding to and/or acknowledging one or more requests from the first PEGC for a predetermined time period.

Additionally or alternatively, the first PEGC may determine to send the unavailable message based on a percentage of first PEGC requests that receive a response or acknowledgement from the first PINE falling below a predetermined threshold. Additionally or alternatively, the first PEGC may determine to send the unavailable message based on receipt of another message (e.g., from the network) indicating that the first PEGC is no longer authorized to serve as a gateway in the PIN and/or indicating that the first PEGC is no longer authorized to serve as a gateway for the first PINE. Additionally or alternatively, the first PEGC may determine to send the unavailable message based on a number of PINEs that it is providing gateway services to exceeding a predetermined threshold. For example, the first PEGC may determine that it is providing gateway services to too many WTRUs. Additionally or alternatively, the first PEGC may determine to send the unavailable message after receiving a request from the network or the PEMC requesting that the first PEGC select one or more PINEs to no longer serve. The PEMC may send the request to the first PEGC to change a distribution of PINEs among the PEGCs. Additionally or alternatively, he first PEGC may determine to send the unavailable message when the PEGC is powering down.

The PEMC may determine that the first PEGC is unreachable and/or not available to serve as the gateway for the first PINE. The PEMC may determine that the first PEGC is unreachable and/or not available as a gateway based on a trigger from the user and/or the first PEGC not communicating with the PEMC. For example, the trigger may include a change in one or more GUI settings associated with the PEMC. When the first PEGC has not checked in with the PEMC after a predetermined time period, the PEMC may determine that the first PEGC is unreachable and/or not available as a gateway. For example, the PEMC may receive an unreachable indication associated with the user (e.g., GUI) setting. The PEMC may determine that the first PEGC can no longer act as a gateway for the first PINE based on receipt of the unreachable indication. Additionally or alternatively, the PEMC may determine that the first PEGC is unreachable and/or not available as a gateway based on receipt of a report that an amount of data and/or a rate of data communicated with the first PINE has exceeded a predetermined threshold. Additionally or alternatively, the PEMC may determine that the first PEGC is unreachable and/or not available as a gateway based on the first PINE and/or the first PEGC not responding and/or acknowledging one or more PEMC requests for a predetermined time period. For example, the PEMC may make this determination based on a percentage of PEMC requests that receive a response or acknowledgement from the first PINE and/or the first PEGC falling below a predetermined threshold.

The PEMC may determine that the first PEGC is unreachable and/or not available as a gateway based on receipt of a message from the network indicating that the first PEGC is no longer authorized to serve as a gateway in the PIN and/or that the first PEGC is specifically no longer authorized to serve as a gateway for the first PINE. Additionally or alternatively, the PEMC may determine that the first PEGC is unreachable and/or not available as a gateway based on a number of PINEs that are receiving gateway services from the first PEGC exceeding a predetermined threshold (e.g., the PEMC determines that the first PEGC is providing gateway services to too many WTRUs). For example, the PEMC may determine to send the message after receiving a request from the network to change the distribution of PINEs among the PEGCs.

PEGC selection may be triggered by one or more of the first PINE informing the PEMC that the first PEGC is unavailable and/or not reachable, the first PEGC informing the PEMC that it is unavailable and/or not reachable, and/or the PEMC detecting that the first PEGC is unavailable and/or not reachable. The PEGC selection may be performed such that a replacement (e.g., new) PEGC can be selected to serve the first PINE.

Network assisted detection may be used to determine that the first PEGC is unavailable and/or not reachable. The network may detect that the first PEGC is either unavailable and/or not reachable and informs the PEMC that the first PEGC is no longer suitable to act as a gateway, for example, using layer 3 NAS signaling. For example, the network may send an unavailable message associated with the first PEGC to the PEMC. The unavailable message from the network may trigger the PEMC to select a new gateway to serve the first PINE, for example, as described herein. The trigger for the unavailable message from the network may come from another network function (NF) e.g., PCF and/or PIN-MF (PIN management function).

The unavailable message from the network to the PEMC may include one or more of the following information elements. A first information element (e.g., an unreachable information element) in the unavailable message may indicate that first PEGC is not reachable (e.g., out of coverage or has been switched off). A second information element (e.g., a deauthorization information element) in the unavailable message may indicate that the first PEGC has been deauthorized and/or is no longer allowed to operate as a PIN Gateway. A third information element (e.g., PIN gateway information element) in the unavailable message may indicate that the first PEGC cannot serve as PIN gateway for the PINEs in the first PINE set, but may still be able to provide PIN gateway functionalities to other PINEs. A fourth information element (e.g., a maximum capacity information element) in the unavailable message may indicate that a maximum capacity has been reached for the first PEGC. For example, the first PEGC may be able (e.g., only able) to support a threshold number of PINEs, The PEMC may move other PINEs (e.g., exceeding the threshold number of PINEs) to one or more different PIN gateways.

The PCF or PIN-MF NAS may determine to send the unavailable message to the PEMC after receiving a request to update a policy that is associated with the PIN. For example, the policy that is used to determine which WTRUs are authorized to belong to the PIN, how many PINEs may join the PIN, which PINEs may join the PIN, and/or which WTRUs may act as a PEGC in the PIN.

As described herein, reception of the NAS message from the network may cause the PEMC to send a message to the first PINE and/or the first PEGC notifying the first PINE and/or the first PEGC of the need to change the association between the first PINE and the first PEGC.

In some embodiments, PEGC selection for the first PINE may be triggered. The PEMC may select the PEGC for the first PINE. For example, the PEMC may authorize and/or select another PEGC (e.g., such as PEGC-3) as the gateway (e.g., new gateway) for the first PINE. Authorization of another PEGC may include capability exchange between the other PEGC (e.g., PEGC-3) and the network (e.g., AMF). Authorization of another PEGC may require explicit authorization from core network and/or application layer to take up the role of PEGC. The PEMC may send a message to the other PEGC (e.g., PEGC-3) to notify the other PEGC that it should serve as the gateway for the first PINE, for example.

In some embodiments, the PEMC may configure the first PINE with a gateway configuration. The PEMC may send the gateway configuration to the first PINE. The gateway configuration may include information that indicates that the other PEGC (e.g., PEGC-3) may be a new PIN gateway for the first PINE. The first PINE may use the gateway configuration from PEMC to connect with the other PEGC (e.g., PEGC-3).

In some embodiments, discovery and/or selection of a PEGC may be triggered by a change in the configuration of the PIN. The change in configuration of the PIN may include addition of PINE(s) and/or a change of PIN characteristics.

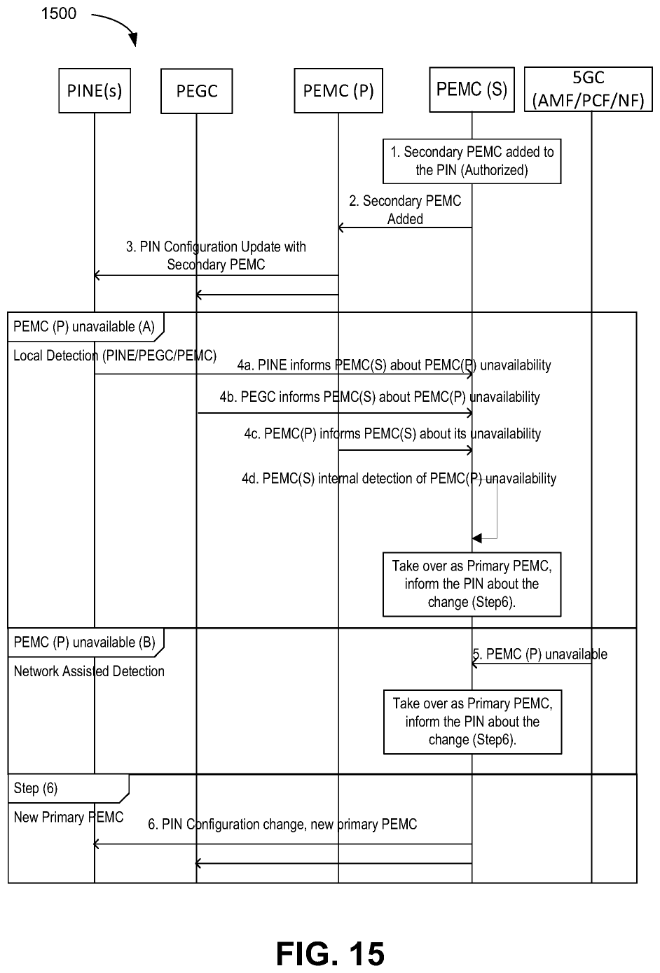

A device that serves as a PEMC for a PIN may need to change. FIG. 15 depicts an example process 1500 to change the PEMC for a PIN from a first device (e.g., PEMC (P)) to a second device (e.g., PEMC(S)).

In some embodiments, PIN setup may be provided. A PIN may include a plurality of PEMCs. A first PEMC (e.g., PEMC (P) may be the primary PEMC. A second PEMC (e.g., PEMC(S)) may be the secondary PEMC and/or may be an additional PEMC that is being added to the PIN. Each PIN may include one or more secondary PEMCs, for example.

In some embodiments, an additional PEMC may be authorized for the PIN. For example, a device may be authorized to serve as a secondary PEMC(S). The secondary PEMC(S) may inform the primary PEMC (P) about its presence and/or that it is authorized to behave as a PIN element with management capability. Additionally or alternatively, the secondary PEMC(S) may inform the PEMC (P) about its presence and/or that it is authorized to behave as a PIN element with management capability. For example, the secondary PEMC(S) may inform the PEMC (P) about its presence and/or that it is authorized to behave as a PIN element with management capability via the network. For example, the PCF and/or PIN-MF may send a NAS message to the PEMC (P). The NAS message may indicate that the secondary PEMC(S) may be capable of serving as a management entity in the PIN, for example.

In some embodiments, the primary PEMC (P) may update the PIN with the configuration. For example, the primary PEMC (P) may add the secondary PEMC(S). Updating the PIN may involve sending a message to each element in the PIN (e.g., the PINEs and PEGCs) to notify the elements in the PIN that the secondary PEMC(S) is the secondary management entity for the PIN, for example. The message may include an identity (e.g., an identifier) of the secondary PEMC(S) and/or an address of the secondary PEMC(s). Alternatively or additionally, the message may be sent to the PIN elements by the PCF and/or PIN-MF (e.g., via a NAS notification).

In some embodiments, the PIN may determine locally that the PEMC (P) is unavailable. A PINE may inform the secondary PEMC(S) about the unavailability/unreachability of the primary PEMC (P). For example, the PINE may send a primary PEMC (P) unavailable indication to the secondary PEMC(S). A PEGC may inform the secondary PEMC(S) about the unavailability/unreachability of the primary PEMC (P), for example. The primary PEMC (P) may inform the secondary PEMC(S) about its unavailability/unreachability, for example, based on a change of settings by the user (e.g., via GUI) and/or the network (e.g., PIN Management Function PINMF). The change of settings by the user (e.g., via GUI) and/or the network may deauthorize the primary PEMC (P) to operate as a PEMC for the PIN. For example, a change of settings by a user may trigger the primary PEMC (P) to send a message to the secondary PEMC(S). The message may include that the primary PEMC (P) is no longer configured to provide management functionality. For example, a power down procedure may trigger the primary PEMC (P) to send a message to the secondary PEMC(S) that the primary PEMC (P) is no longer configured to provide management functionality. For example, the primary PEMC (P) may determine that it will soon relocate and will no longer be able to provide management functionality to the PIN.

The secondary PEMC(S) may detect (e.g., internally detect) that the primary PEMC (P) is no longer reachable and/or available, and/or shall take over as the primary PEMC for the PIN. For example, the secondary PEMC(S) may determine that the primary PEMC (P) is not reachable when the primary PEMC (P) does not respond to and/or acknowledge a predetermined number of messages from the secondary PEMC(S), for example, in a predetermined time period.

The secondary PEMC(S) may take over as primary PEMC for the PIN.

In some embodiments, detection of primary PEMC (P) unavailability may be network assisted. The secondary PEMC(S) may receive an indication from the network that the primary PEMC (P) is unavailable, for example.

In some embodiments, the network (e.g., the PCF or PIN-MF) may inform the secondary PEMC(S) about the unavailability of the primary PEMC (P), for example, via NAS signaling. For example, the network may send an unavailable message to the secondary PEMC(S). The unavailable message may be triggered by the network, for example, when the primary PEMC (P) is out of coverage and/or has not responded to periodic updates or downlink paging messages or the primary PEMC (P) has been deauthorized by the network/network function (e.g., such as PCF/PINMF) and/or when the primary PEMC (P) de-registers from the network.

The secondary PEMC(S) may take over as the primary PEMC for the PIN. The secondary PEMC(S) may inform one or more PIN elements (e.g., including PEGCs and additional PEMCs) about the change in PEMC and/or PIN configuration. For example, the secondary PEMC(s) may send a notification associated with the change in PEMC and/or PIN configuration. The notification may indicate to the PIN elements that the secondary PEMC(S) may now be the management function for the PIN. The PIN elements may recognize the secondary PEMC(S) as the PIN element with management functionality for the PIN, for example.

In some embodiments, a PIN may have only a primary PEMC. For example, the PIN may not have any secondary PEMCs. In some embodiments there may be a trigger for a new authorization procedure within the PIN for PIN elements which have management capabilities to take over the responsibilities of the unavailable PEMC (e.g., primary PEMC). For example, unavailability of the primary PEMC may trigger a new authorization procedure within the PIN for PIN elements which have management capabilities to take over the responsibilities of the unavailable PEMC (e.g., primary PEMC).

What is claimed is:

1-20. (canceled)

21. A wireless transmit/receive unit (WTRU), comprising:
a processor and memory configured to:
receive one or more reports from one or more other WTRUs, each report of the one or more reports indicating a plurality of personal Internet of Things network (PIN) gateways discovered by the respective other WTRU, and each of the PIN gateways being associated with a respective PIN gateway identifier (ID);
receive PIN gateway selection policy information from a core network node; and
select a PIN gateway from the plurality of PIN gateways for the one or more other WTRUs based on the PIN gateway selection policy information received from the core network node.

22. The WTRU of claim 21, wherein the PIN gateway selection policy information indicates one or more of a preferred PIN gateway, a type of PIN supported, a quality of service (QoS) supported, and an associated 5G core network identifier.

23. The WTRU of claim 21, wherein the PIN gateway selection policy information comprises a prioritized PIN gateway list received from the core network node.

24. The WTRU of claim 23, wherein the prioritized PIN gateway list is received from the core network node based on a request sent from the WTRU to the core network node, the request including location information.

25. The WTRU of claim 21, wherein a policy parameter is preconfigured at an application layer of the WTRU or received during an initial registration from the core network at an application layer of the WTRU, and wherein the processor and memory configured to select the PIN gateway from the plurality of PIN gateways for the one or more other WTRUs further comprises the processor and memory being configured to select the PIN gateway from the plurality of gateways for the one or more other WTRUs based on the policy parameter.

26. The WTRU of claim 21, wherein the processor and memory are further configured to request a policy parameter based on a type of PIN supported.

27. The WTRU of claim 21, wherein the processor and memory are further configured to:
receive a message comprising an indication of a capability associated with a PIN gateway, and wherein the processor and memory configured to select the PIN gateway from the plurality of PIN gateways for the one or more other WTRUs further comprises the processor and memory being configured to select the PIN gateway from the plurality of gateways for the one or more other WTRUs based on the capability.

28. The WTRU of claim 21, wherein the processor and memory are further configured to:
determine a priority for each of the plurality of PIN gateways based on the PIN gateway selection policy information; and
generate a prioritized list of PIN gateways available using the determined priorities.

29. The WTRU of claim 21, wherein the processor and memory are further configured to send a trigger message to a second WTRU based on the WTRU being unavailable.

30. The WTRU of claim 21, wherein the processor and memory are further configured to send an indication indicating the selected PIN gateway to another PIN element.

31. A method implemented by a wireless transmit/receive unit (WTRU), the method comprising:
receiving one or more reports from one or more other WTRUs, each report of the one or more reports indicating a plurality of personal Internet of Things network (PIN) gateways discovered by the respective other WTRU, and each of the PIN gateways being associated with a respective PIN gateway identifier (ID);
receiving PIN gateway selection policy information from a core network node; and
selecting a PIN gateway from the plurality of PIN gateways for the one or more other WTRUs based on the PIN gateway selection policy information received from the core network node.

32. The method of claim 31, wherein the PIN gateway selection policy information indicates one or more of a preferred PIN gateway, a type of PIN supported, a quality of service (QoS) supported, and an associated 5G core network identifier.

33. The method of claim 31, wherein the PIN gateway selection policy information comprises a prioritized PIN gateway list received from the core network node.

34. The method of claim 33, wherein the prioritized PIN gateway list is received from the core network node based on a request sent from the WTRU to the core network node, the request including location information.

35. The method of claim 31, wherein a policy parameter is preconfigured at an application layer of the WTRU or received during an initial registration from the core network at an application layer of the WTRU, and wherein selecting the PIN gateway from the plurality of PIN gateways for the one or more other WTRUs further comprises selecting the PIN gateway from the plurality of gateways for the one or more other WTRUs based on the policy parameter.

36. The method of claim 31, further comprising requesting a policy parameter based on a type of PIN supported.

37. The method of claim 31, further comprising receiving a message comprising an indication of a capability associated with a PIN gateway, and wherein selecting the PIN gateway from the plurality of PIN gateways for the one or more other WTRUs further comprises selecting the PIN gateway from the plurality of gateways for the one or more other WTRUs based on the capability.

38. The method of claim 31, further comprising:
determining a priority for each of the plurality of PIN gateways based on the PIN gateway selection policy information; and
generating a prioritized list of PIN gateways available using the determined priorities.

39. The method of claim 31, further comprising sending a trigger message to a second WTRU based on the WTRU being unavailable.

40. The method of claim 31, further comprising sending an indication indicating the selected PIN gateway to another PIN element.
